(19) United States
(12) Patent Application Publication
(10) Pub. No.: US 2007/0172154 A1
(43) Pub. Date: Jul. 26, 2007

(54) Data medium discrimination information database creating apparatus, data medium discrimination information database managing apparatus, computer readable recording medium recorded thereon data medium discrimination information database creating program, and data medium discriminating apparatus

(75) Inventors: Katsutoshi Kobara, Kawasaki (JP); Shinichi Eguchi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki (JP); FUJITSU FRONTECH LIMITED, Inagi-shi (JP)

(21) Appl. No.: 11/411,825

(22) Filed: Apr. 27, 2006

(30) Foreign Application Priority Data
Jan. 20, 2006 (JP) 2006-012802

(51) Int. Cl. G06K 9/54

(52) U.S. Cl. 382/305

(57) ABSTRACT

An apparatus has a temporary registration unit which extracts candidate information, which can be data medium discrimination information, about a data medium from image data, relates it to the data medium, and register them in a registration candidate database when the data medium discrimination information about the data medium is not retained in a data medium discrimination information database, and a registration unit which relates the candidate information to the kind of the data medium, and registers them as the data medium discrimination information in the data medium discrimination information database. The data medium discrimination information database retaining a pair of the kind of data medium and data medium discrimination information about the data medium used to discriminate the data medium can be automatically kept in the optimal state according to a distribution frequency of the data medium, whereby an excellent rate of document discrimination is attained.

### BACKGROUND OF THE INVENTION

1). Field of the Invention

The present invention relates to a technique for creating and managing a database (data medium discrimination information database), which defines the kind of a document, for use in automatic document discrimination in a document discriminating apparatus which performs automatic discrimination or automatic character recognition of media such as slips, business documents and so forth handled in a financial organ or the like.

2). Description of the Related Art

As an apparatus performing data medium discrimination or character recognition by reading a data medium (for example, a document), as image data, on which information such as characters, codes, numeric characters, pictures, ruled lines, barcodes and so forth are indicated, there have been developed in these years document discriminating apparatuses such as an optical character reading apparatus [OCR (Optical Character Recognition/Reader) apparatus] and the like. Various kinds of industries make widely use of the document discriminating apparatus to improve, for example, the efficiency of the business.

For example, an operator doing the window working in a financial organ or the like uses the document discriminating apparatus to efficiently handle document media (hereinafter, referred to simply documents), thereby improving the efficiency of his/her work.

With respect to such document discriminating apparatus, there is a technique of not only handling a large amount of the same kind of documents but also automatically handling documents in various formats in order to carry out the document handling more efficiently (refer to Patent Documents 1 through 4 below, for example).

In such document discriminating apparatus, document discrimination information used to discriminate a document (the kind of document) is related to a document kind, they are registered in the database in prior, document discrimination information obtained from image data of a document is collated with the document discrimination information registered in the database, whereby the document is discriminated.

When the document discrimination information acquired from the image data, which is obtained by reading a document to be discriminated, is registered and retained in the database, it is determined that the document to be discriminated is a document kind represented by the document discrimination information registered in the database.

When the document discrimination information obtained from the image data is not registered and retained in the database, it is impossible to discriminate the document on the basis of the database.

When the number of kinds of handled documents to be discriminated (hereinafter, referred to simply as documents) is small, the known document discriminating apparatus can register document discrimination information on all the documents in the database. To the contrary, when the number of kinds of handled documents to be discriminated is large and every kind of documents cannot be registered in the database, the person in charge (worker; for example, operator) selects documents to be registered in the database.

With respect to the known document discriminating apparatus, the person in charge has to determine visually a document considered to be important. Thus, the person in charge is required to have expert knowledge of handled documents.

For example, the person in charge is required specific expert knowledge of documents such as documents of a kind revised every year, documents of another kind revised at irregular intervals, documents of still another kind handled in only a specific period of time and so forth.

When the person in charge manually does the registering process, the registering process largely relies on the ability or experiences of the person in charge, which imposes a large burden on the person in charge.

If the number of kinds of handled documents is several tens, the manual registering process is possible. However, the financial organ or the like handles several hundreds kinds of documents at any time, some of which may be updated, for example. As a result, the financial organ or the like handles more than several thousands of kinds of documents in a year.

Actually, it is difficult to perform manually the registration process on an enormous number of kinds of documents, from the viewpoint of the number of steps of the work.

In the financial organs and the like, it is very important to register document discrimination information on a revised document or a new document prepared due to, for example, reorganization of the bank, or a private document in a new format brought by an end user. However, it is difficult to register all documents from the viewpoint of the number of the steps, and to dispense with redundant works.

If several thousands of kinds of documents are all registered in the database, the number of analogous documents is increased because the number of document kinds is increased, which leads to a high possibility of erroneous discrimination. This further leads to degradation of the discrimination rate. Therefore, registering all kinds of documents in the database is not preferable from the viewpoint of degradation of the discrimination rate.

The known document discriminating apparatus registers all document kinds or document kinds selected by a person in charge in the database, not having a function of deleting a document kind that has been already registered in the database.

It is possible that the person in charge deletes unnecessary document kinds from the database. However, what document kind is deleted from the database has to be determined according to not only the frequency of distribution (the number of time of handling) of the documents of this kind but also the characteristic of distribution (handling) of documents of this kind because some of the document kinds are handled in only a specific period of time within a month or year. This requires the person in charge to have higher-level expert knowledge. When several hundreds or several thousands of kinds of documents are handled, it is practically difficult that only the person in charge manually carries out the deleting work.

[Patent Document 1] International Publication No. WO97/05561

[Patent Document 2] Japanese Patent Application Laid-Open Publication No. 2001-325563

[Patent Document 3] International Publication No. WO01/26024

[Patent Document 4] Japanese Patent Application Laid-Open Publication No. 2003-168075

### SUMMARY OF THE INVENTION

In the light of the above problems, an object of the present invention is to automatically keep a database (medium discrimination information database), which retains a pair of a data medium kind and medium discrimination information thereof used to discriminate the data medium, in the optimal state according to the distribution frequency of the data medium, thereby to attain an excellent rate of document discrimination.

To attain the above object, the present invention provides a data medium discrimination information database creating apparatus creating a data medium discrimination information database which relates data medium discrimination information used to discriminate a data medium on the basis of image data obtained by reading the data medium on which information is indicated to a data medium kind of the data medium, and retains the data medium discrimination information and the data medium kind, the data medium discrimination information database creating apparatus comprising a determining unit for determining whether or not the data medium discrimination information on the data medium obtained from the image data of the data medium is retained in the data medium discrimination information database, a temporary registration unit for extracting candidate information which can be the data medium discrimination information on the data medium from the image data when the determining unit determines that the data medium discrimination information on the data medium is not retained in the data medium discrimination information database, relating the candidate information to the data medium, and registering the candidate information and the data medium in a registration candidate database, and a registration unit for relating the candidate information to the data medium kind of the data medium, and registering the candidate information and the data medium kind of the data medium as the data medium discrimination information in the data medium discrimination information database on the basis of a registration frequency of the candidate information into the registration candidate database by the temporary registration unit.

It is preferable that the temporary registration unit extracts plural kinds of candidate information from the data medium, and registers the extracted candidate information in the registration candidate database, and the registration unit divides a plurality of data media registered in the registration candidate database into a plurality of groups on the basis of the plural kinds of candidate information, and determines a data medium kind to be registered in the data medium discrimination information database on the basis of the registration frequencies of data media in each of the divided groups.

It is preferable that the temporary registration unit extracts plural kinds of candidate information from the data medium, and registers the extracted candidate information in the registration candidate database, and the registration unit determines a data medium kind to be registered in the data medium discrimination information database on the basis of a value obtained by totaling registration frequencies of the plural kinds of candidate information on each data medium.

It is preferable that the data medium discrimination information database creating apparatus further comprises a distribution frequency database for retaining a distribution frequency of each data medium kind whose data medium discrimination information is retained in the data medium discrimination information database, an updating unit for updating the distribution frequency of a data medium kind in the distribution frequency database when the determining unit determines that data medium discrimination information on the data medium is retained in the data medium discrimination information database, and a deleting unit for deleting a pair of a data medium kind and data medium discrimination information thereof from the data medium discrimination information database on the basis of the distribution frequency of the data medium kind in the distribution frequency database.

The present invention further provides a data medium discrimination information database managing apparatus managing a data medium discrimination information database which relates data medium discrimination information used to discriminate a data medium on the basis of image data obtained by reading the data medium on which information is indicated to a data medium kind of the data medium, the data medium discriminating information database managing apparatus comprising a distribution frequency database for retaining a distribution frequency of each data medium kind whose data medium discrimination information is retained in the data medium discrimination information database, a determining unit for determining whether or not data medium discrimination information on the data medium obtained from the image data of the data medium is retained in the medium discrimination information database, an updating unit for updating the distribution frequency of a data medium kind of the data medium in the distribution frequency database when the determining unit determines that the data medium discrimination information on the data medium is retained in the data medium discrimination information database, and a deleting unit for deleting a pair of a data medium kind and data medium discrimination information thereof from the data medium discrimination information database on the basis of the distribution frequency of the data medium kind in the distribution frequency database.

According to the present invention, the registration unit relates candidate information to a document kind on the basis of a registration frequency of the candidate information in the registration candidate database registered by the temporary registration unit, and registers them as the data medium discrimination information in the data medium discrimination information database. Therefore, a person in charge who is required to have exclusive knowledge to register data media becomes unnecessary, and the data medium discrimination information database can be updated to an excellent one according to the distribution frequency of the data medium kind. As a result, the data medium discrimination rate is improved, and a stable, excellent data medium discrimination rate can be realized.

The deleting unit deletes a pair of a data medium kind and data medium discrimination information thereof from the data medium discrimination information database on the basis of the distribution frequency of each data medium kind retained in the distribution frequency database. It is thus possible to delete a pair of an unnecessary data medium kind whose distribution frequency is small and date medium discrimination information thereof from the data medium discrimination information database. As a result, the data medium discrimination rate can be prevented from being dropped because the number of data medium kinds retained in the data medium discrimination information database is increased, which allows a stable, excellent data medium discrimination rate.

The registration unit and the deleting unit associate with each other to keep, at any time, data in the data medium discrimination information database in an excellent state, by registering a data medium kind whose frequency in use is large, while deleting a data medium kind whose frequency in use is small, whereby the retrieval rate of the data medium discrimination information database at the time of discrimination is improved.

### BRIEF DESCRIPTION OF THE DRAWINGS

FIG. 1 is a block diagram showing a structure of a document discriminating apparatus according to an embodiment of this invention;

FIG. 2 is a diagram showing an example of a structure of a computer by which the document discriminating apparatus according to the embodiment of this invention is accomplished;

FIG. 3 is a diagram showing an example of a structure of a registration database of the document discriminating apparatus according to the embodiment of this invention;

FIG. 4 is a diagram showing an example of a structure of a registration candidate database of the document discriminating apparatus according to the embodiment of this invention;

FIG. 5 is a diagram showing an example of a structure of a keyword database in a registration unit of the document discriminating apparatus according to the embodiment of this invention;

FIG. 6 is a diagram showing an example of a structure of the registration candidate database of the document discriminating apparatus according to the embodiment of this invention;

FIG. 7 is a flowchart showing an example of a procedure of an operation of the registration unit of the document discriminating apparatus according to an embodiment of this invention;

FIG. 8 is a diagram showing an example of a structure of a distribution frequency database of the document discriminating apparatus according to the embodiment of this invention;

FIG. 9 is a diagram showing an example of a distribution characteristic of documents handled by the document discriminating apparatus according to the embodiment of this invention;

FIG. 10 is a diagram showing another example of the distribution characteristic of documents handled by the document discriminating apparatus according to the embodiment of this invention;

FIG. 11 is a diagram showing still another example of the distribution characteristic of documents handled by the document discriminating apparatus according to the embodiment of this invention;

FIG. 12 is a diagram showing still another example of the distribution characteristic of documents handled by the document discriminating apparatus according to the embodiment of this invention;

FIG. 13 is a diagram showing an example of results of calculation of registration frequencies of one kind of candidate information by the registration unit in a document discriminating apparatus according to a first modification of this invention;

FIG. 14 is a diagram for illustrating a method of determining a document kind by the registration unit in the document discriminating apparatus according to the first modification of this invention;

FIG. 15 is a diagram showing an example of a structure of the registration candidate database in a document discriminating apparatus according to a second modification of this invention;

FIG. 16 is a diagram showing an example of results of calculation of registration frequencies by the registration unit in the document discriminating apparatus according to the second modification of this invention;

FIG. 17 is a diagram showing an example of weighting coefficients for candidate information used by the registration unit in the document discriminating apparatus according to the second modification of this invention;

FIG. 18 is a diagram showing an example of results of calculation of scores of a plurality of documents by the registration unit in the document discriminating apparatus according to the second modification of this invention; and

FIG. 19 is a flowchart showing an example of a procedure of an operation by the registration unit in the document discriminating apparatus according to the second modification of this invention.

### DESCRIPTION OF THE PREFERRED EMBODIMENTS

Now, description will be made of embodiments of the present invention with reference to the accompanying drawings.

### [1] Embodiment of the Invention

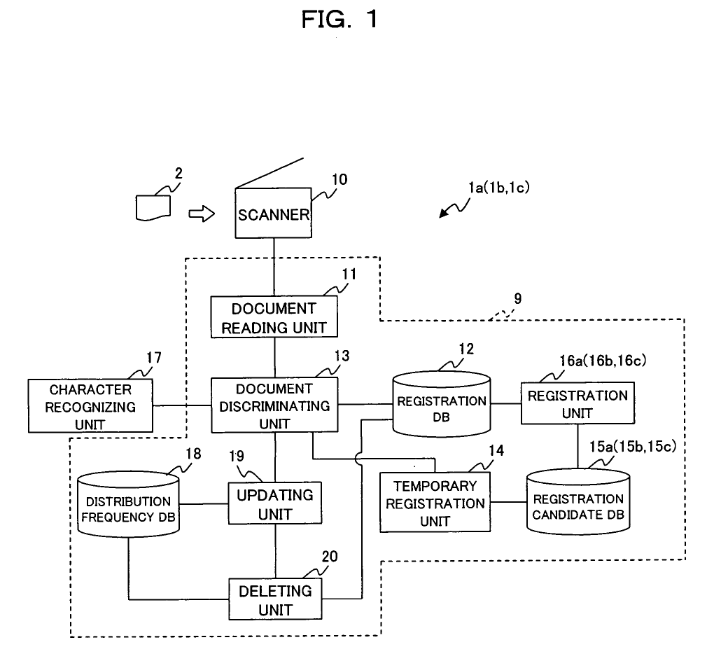

First, description will be made of a structure of a document discriminating apparatus (data medium discriminating apparatus) according to an embodiment of this invention with reference to a block diagram shown in FIG. 1. As shown in FIG. 1, a document discriminating apparatus 1a comprises a scanner (image data obtaining unit) 10, a document reading unit 11, a registration database (document discrimination information database; denoted as “registration DB” in the drawing) 12, a document discriminating unit 13, a temporary registration unit 14, a registration candidate database (denoted as “registration candidate DB” in the drawing) 15a, a registration unit 16a, a character recognizing unit 17, a distribution frequency database (denoted as “distribution frequency DB” in the drawing) 18, an updating unit 19, and a deleting unit 20.

In the document discriminating apparatus 1a, the document reading unit 11, the registration database 12, the document discriminating unit 13, the temporary registration unit 14, the registration candidate database 15a, the registration unit 16a, the distribution frequency database 18, the updating unit 19 and the deleting unit 20 function together as a data medium discrimination information database creating (managing) apparatus 9 of this invention.

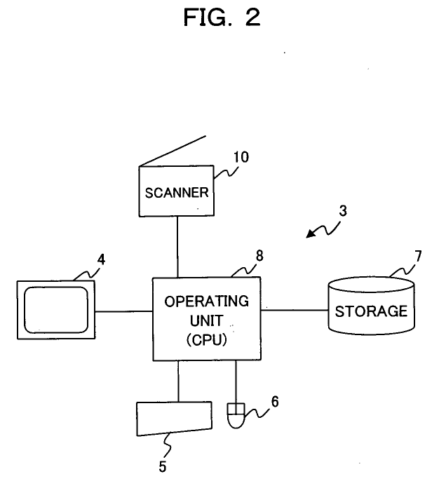

As shown in FIG. 2, the document discriminating apparatus 1a is implemented by an operating unit (for example, CPU: Central Processing Unit) 8 of a computer having a display unit 4, a keyboard 5 and a mouse 6 which function as input interfaces, and a storage 7.

Namely, the scanner 10 of the document discriminating apparatus 1a is connected to the operating unit 8, while the document reading unit 11, the document discriminating unit 13, the temporary registration unit 14, the registration unit 16a, the character recognizing unit 17, the updating unit 19 and the deleting unit 20 of the document discriminating apparatus 1a are implemented by that the operating unit 8 executes a predetermined application program [for example, a data medium discrimination information database creating (managing) program].

The scanner 10 optically reads a document 2, which is a data medium on which information is indicated, to obtain image data thereof.

The document reading unit 11 reads the image data obtained by reading the document 2 by the scanner 10.

The registration database 12 retains document discrimination information (data medium discrimination information), which is characteristics of each kind of documents, used to discriminate the kind of a document. In the registration database 12, the kind of a document is related to document discrimination information on this document kind, and retained.

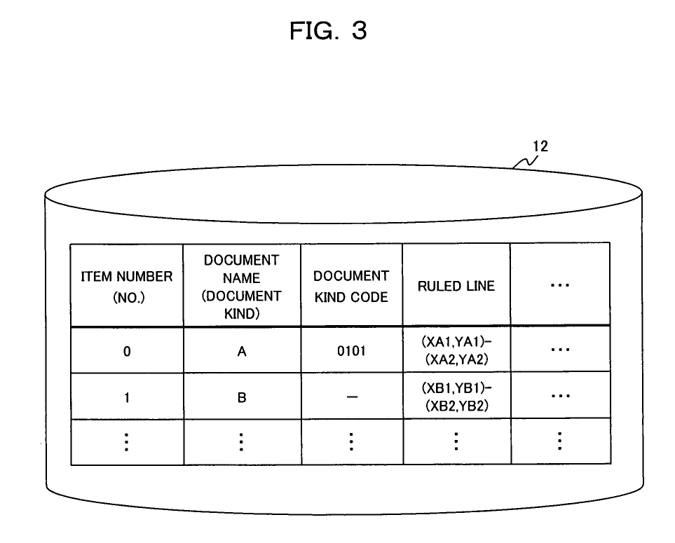

In concrete, as shown in FIG. 3, the registration database 12 retains information about a document kind code (document ID), ruled lines and so forth entered in a document for each document name (document kind), as the document discrimination information. Namely, with respect to a document name “A,” information about a document ID “0101,” ruled lines “(XA1, YA1)-(XA2, YA2)” are retained. With respect to a document name “B,” information about an ID number “-(none),” ruled lines “(XB1, YB1)-(XB2, YB2)” are retained.

Note that the sorts of document discrimination information retained in the registration database 12 are not limited, but any sort of document discrimination information can be retained in the registration database 12 so long as the document discriminating unit 13 can certainly discriminate the kind of document by it. As the document discrimination information retained in the registration database 12 other than the information about the document ID and ruled lines, there can be “document kind code,” “payer code,” “payee code,” “fixed phrase,” “presence/absence of seal impression,” “position of seal impression,” etc., for example, as character information other than the document ID entered in a document, and “document size,” “hue system,” “handling time,” etc. as information other than the character information.

The document discriminating unit 13 discriminates the document 2 on the basis of the image data of the document 2 read by the document reading unit 11 and the document discrimination information retained in the registration database 12. Namely, the document discriminating unit 13 discriminates the kind of the document 2 obtained as image data, on the basis of the document discrimination information retained in the registration database 12. The document discriminating unit 13 retrieves document discrimination information on the document 2 obtained from the image data of the document 2 in the registration database 12, and discriminates the kind of the document 2 agreeing with the retrieved document discrimination information as a document kind.

As above, the document discriminating unit 13 functions as a determining unit which determines whether or not document discrimination information on the document 2 obtained from the image data of the document 2 is retained in the registration database 12.

When the document discriminating unit 13 determines that the document discrimination information on the document 2 is not retained in the registration database 12, namely, when the document discriminating unit 13 is unable to discriminate the document 2, the temporary registration unit 14 extracts candidate information that can be the document discrimination information on the document 2 from the image data of the document 2, relates it to the document 2, and registers them in the registration candidate database 15a.

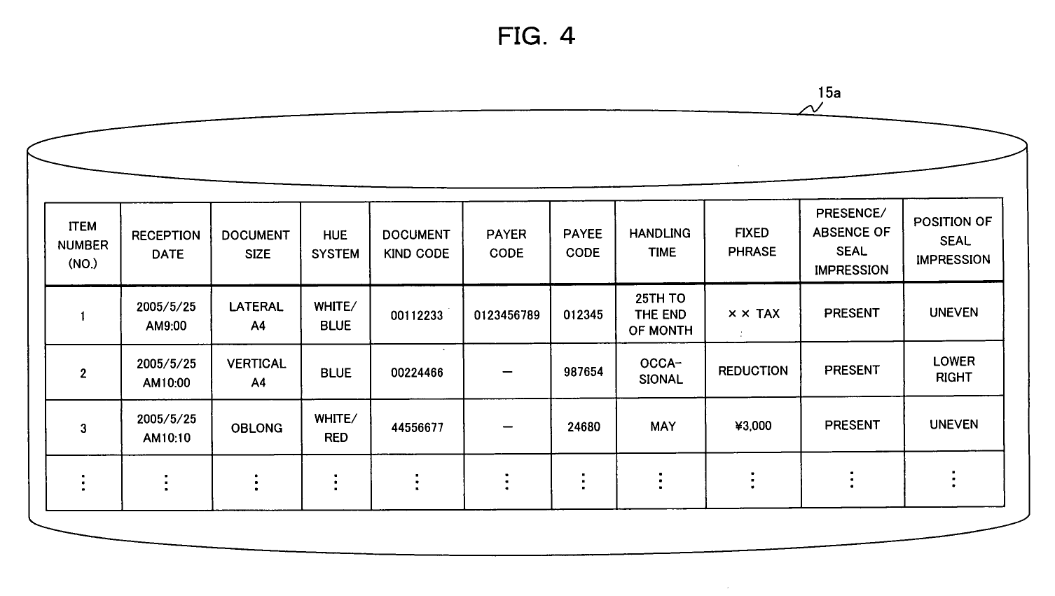

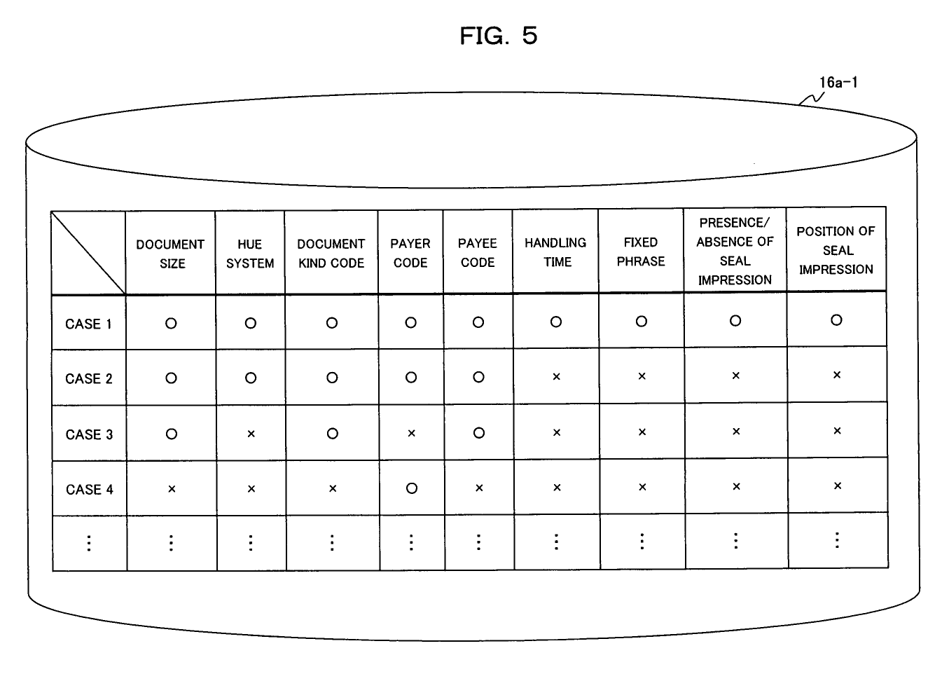

FIG. 4 shows an example of a structure of the registration candidate database 15a. The temporary registration unit 14 extracts candidate information as shown in FIG. 4, which can be document discrimination information, from information indicated on the document 2 on the basis of the image data of the document 2 whose document discrimination information has not been discriminated. Namely, the temporary registration unit 14 extracts “document size,” “hue system,” “document kind code.” “payer code,” “payee code,” “handling time,” “fixed phrase,” “presence/absence of seal impression” and “position of seal impression,” together with a reception date (namely, handling date) of the document 2, from the image data of the document 2, and registers them in the registration candidate database 15a. Incidentally, these pieces of candidate information correspond to all keywords in a keyword database 16a-1 shown in FIG. 5 to be described later.

The registration unit 16a relates candidate information to a document kind on the basis of a frequency of registration of the candidate information into the registration candidate database 15a by the temporary registration unit 14, and registers them as the document discrimination information in the registration database 12.

The registration unit 16a divides a plurality of documents registered in the registration candidate database 15a into a plurality of groups according to plural sorts of candidate information, determines a document kind to be registered in the registration database 12 on the basis of the registration frequency (that is, the number of times of registration) of documents in each of the divided groups, and registers it in the registration database 12.

Practically, the registration unit 16a divides documents registered in the registration candidate database 15a by using candidate information as keywords retained in the keyword database 16a-1 shown in FIG. 5, for example, and registers a group having a larger number of documents (that is, having a larger registration frequency of the same kind of documents).

The registration unit 16a registers a document kind of documents in the registration database 12, the number of which is equal to or more than a predetermined value, in each of the divided group. Alternatively, the registration unit 16a registers a predetermined number of document kinds in descending order of the number of documents (namely, registers a predetermined number of document kinds having a larger number of documents, ranging from the top-ranked to a predetermined lower-ranked, in order) in the registration database 12.

Now, the keyword database 16a-1 shown in FIG. 5 will be described. The keyword database 16a-1 retains keywords used in the dividing process on plural kinds of candidate information that can be registered as the document discrimination information in each of a plurality of cases (here, cases 1 to 4). In each case shown in FIG. 5, “∘” represents a keyword used in the dividing process, whereas “X ” represents one not used in the dividing process. In case 1, all kinds of candidate information (“document size,” “hue system,” “document kind code,” “payer code,” “payee code,” “handling time,” “fixed phrase,” “presence/absence of seal impression” and “position of seal impression”) are used as keywords. In case 2, “document size,” “hue system,” “document kind code,” “payer code” and “payee code” are used as keywords. In case 3, “document size,” “document kind code” and “payer code” are used as keywords. In case 4, “payer code” is used as a keyword.

Moreover, which one among the cases 1, 2, 3 and 4 is used to divide a plurality of documents registered in the registration candidate database 15a by the registration unit 16a may be determined according to the document kind to be registered, or determined according to the number of document kinds to be registered in the registration database 12, or selected voluntarily by the operator with the keyboard 5 and the mouse 6. When the way of division is determined according to the document kind to be registered, for example, the case 3 may be selected if a single-sheet document is handled, or the case 4 may be selected if a serial-sheet document is handled.

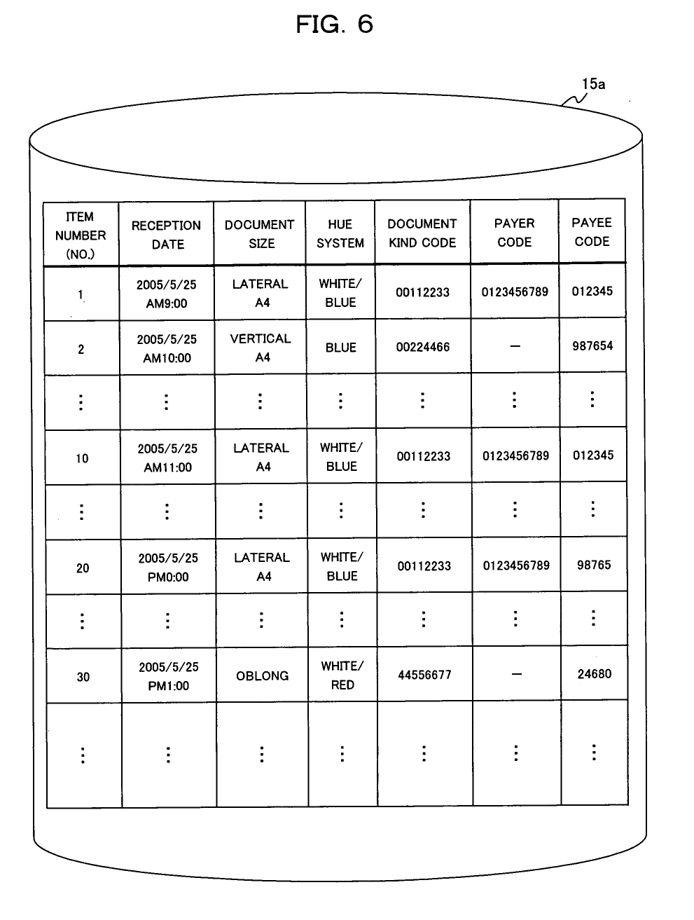

Assuming here that the registration unit 16a divides documents registered in the registration candidate database 15a, by using the keywords in the case 2 in the keyword database 16a-1. In this case, the registration unit 16a gives attention to “document size,” “hue system,” “document kind code,” “payer code” and “payee code” in the registration candidate database 15a shown in FIG. 4, and carries out the dividing process as shown in FIG. 6.

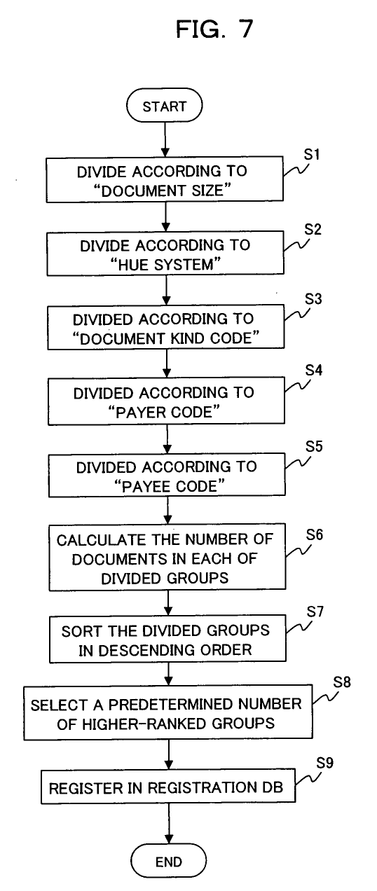

A procedure of the operation of the registration unit 16a at this time is shown in a flowchart (steps S1 to S9) in FIG. 7. As shown in FIG. 7, the registration unit 16a first divides (classifies) a plurality of documents registered in the registration candidate database 15a shown in FIG. 6 into groups according to the document size (step S1), divides according to the hue system (step S2), divides according to the document kind code (step S3), divides according to the payer code (step S4), and divides according to the payee code (step S5).

The registration unit 16a calculates the number of documents in each of the divided groups (step S6), sorts the groups in the descending order of the number of calculated documents, and re-arranges them (step S7).

The registration unit 16a selects a predetermined number of higher-ranked groups as the document kinds to be registered (step S8), and registers these selected groups together with their candidate information in the registration database 12 (step S9).

With respect to the groups selected (determined) at the step S8, the registration unit 16a relates candidate information of the document kinds represented by these groups to these document kinds, and registers them as the document discrimination information in the registration database 12 (step S9).

As shown in FIG. 1, when the document discriminating unit 13 determines that document discrimination information on the document 2 is retained in the registration database 12, that is, when the document discriminating unit 13 can discriminate the document 2, the character recognizing unit 17 recognizes character information and the like indicated on the document 2 on the basis of the document kind of the discriminated document 2.

The character recognizing unit 17 has a database (not shown), which shows what information is indicated at which position on the document for each kind of documents, and recognizes characters on the document 2 on the basis of this database.

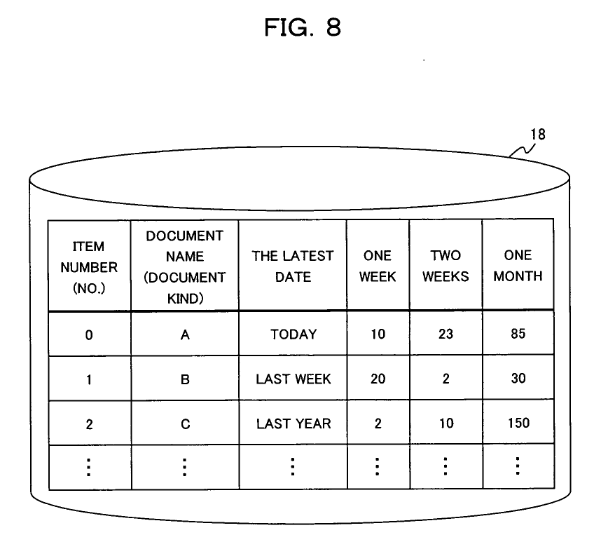

The distribution frequency database 18 retains a distribution frequency (frequency of handling; the number of times of handling) in the document discriminating apparatus 1a for each kind of documents whose document discrimination information is registered in the registration database 12. As shown in FIG. 8, for example, the distribution frequency database 18 is composed of the latest date when a relevant kind of document was handled, the distribution frequency within one week from the latest date (denoted as “one week” in the drawing), the distribution frequency within two weeks from the latest date (denoted as “two weeks” in the drawing), the distribution frequency within one month from the latest date (denoted as “one month” in the drawing), for each kind of documents.

When the document discriminating unit 13 determines that document discrimination information on the document 2 is retained in the registration database 12, that is, when the document discriminating unit 13 can discriminate the document 2, the updating unit 19 updates the distribution frequency of the relevant kind of the document 2 in the distribution frequency database 18.

In concrete, the updating unit 18 updates “the latest date” in the distribution frequency database shown in FIG. 8 to “today,” and counts up the values of “one week,”, “two weeks” and “one month” by “1.”

The updating process on the distribution frequency database 18 by the updating unit 19 is executed in parallel to the character recognizing process by the character recognizing unit 17.

The deleting unit 20 deletes a pair of a document kind and document discrimination information thereof from the registration database 12 on the basis of the distribution frequency of each document kind in the distribution frequency database 18. The deleting unit 20 deletes a pair of a document kind whose distribution frequency is small in the distribution database 18 and document discrimination information thereof.

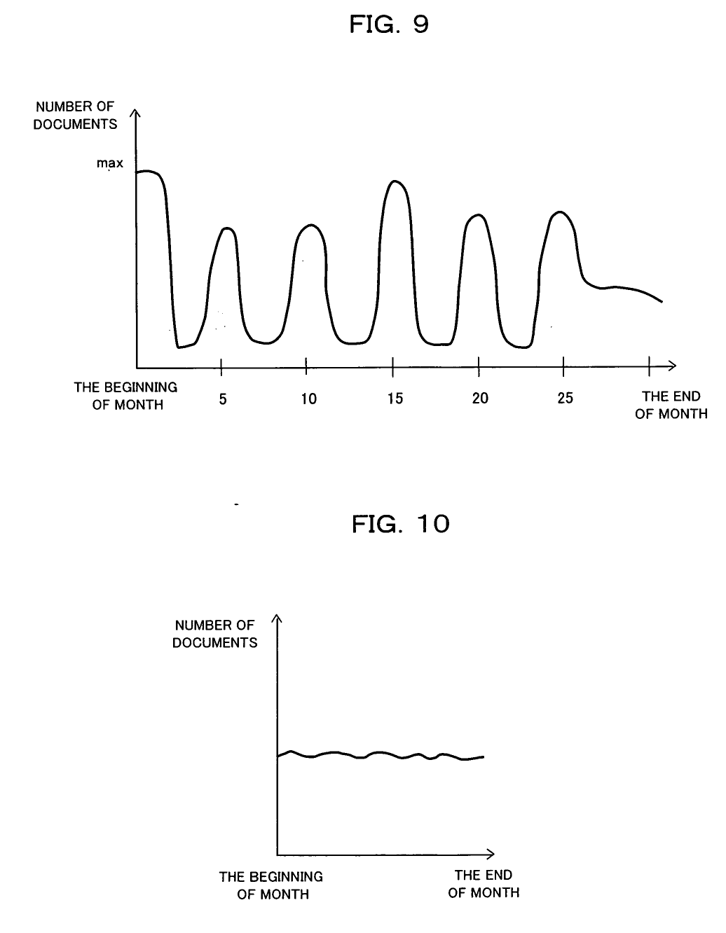

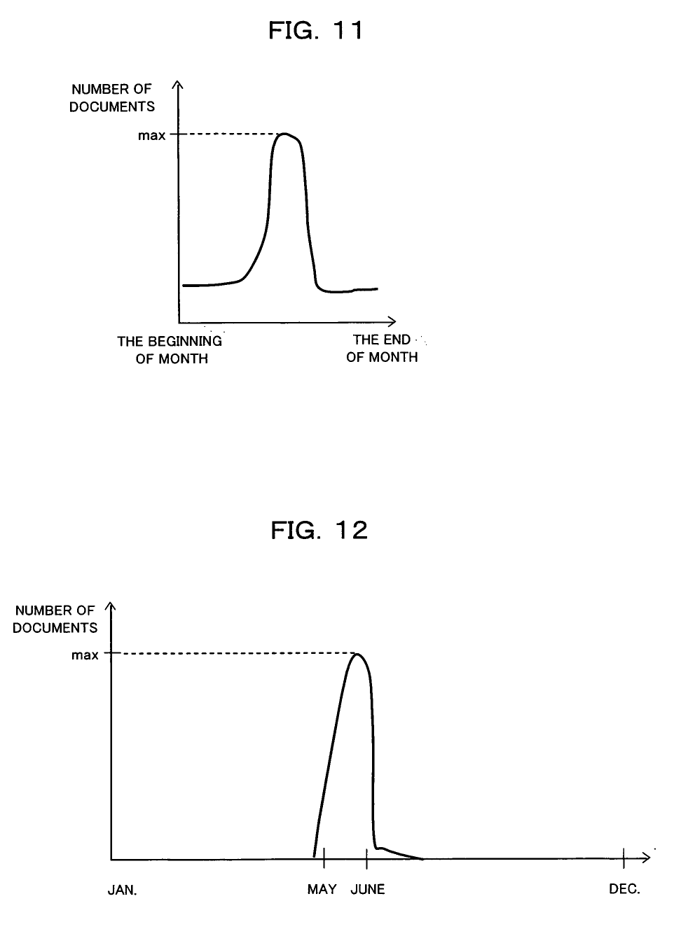

Now, the distribution characteristic of documents to be handled by the document discriminating apparatus 1a will be explained. The document discriminating apparatus 1a is aimed to handle various kinds of documents, thus may be used in the document handling work in a financial organ or the like. In such case, as documents to be handled by the document discriminating apparatus 1a, there are documents of a kind having a distribution characteristic that the distribution frequency of the documents is large before and after 5th, 10th, 15th, 20th, and 25th day within a month as shown in FIG. 9, documents of a kind having a distribution characteristic that the distribution frequency of the documents is approximately constant everyday as shown in FIG. 10, documents of a kind having a distribution characteristic that the distribution frequency of the documents is large particularly before and after a predetermined day in a month as shown in FIG. 11, and documents of a kind having a distribution characteristic that a distribution frequency of the documents appears only before and after a predetermined day in a year as shown in FIG. 12, for example.

Therefore, the deleting unit 20 selects a document kind to be deleted from the registration database 12 on the basis of not only the distribution frequency but also the distribution characteristic of each of the document kinds shown in FIGS. 9 through 12. Whereby, it is possible to avoid that document kinds having distribution characteristics that the documents are invariably distributed in a fixed period even if their distribution frequencies in a month or a year are small, like the document kinds shown in FIGS. 11 and 12, are deleted from the registration database 12.

Concretely, the distribution frequency database 18 has a flag to except one from the objects of deletion (so that the one is not deleted), for example. The flag is set “ON” to the document kinds that are invariably distributed within a fixed period as shown in FIGS. 11 and 12, which are desirable not to be deleted. The deleting unit 20 does not delete a document kind to which the flag is set “ON” from the registration database 12.

With respect to a document kind to which the flat is set “OFF,” the deleting unit 20 deletes a document kind whose distribution frequency is small from the registration database 12 on the basis of its distribution frequency retained in the distribution database 18. Concretely, the deleting unit 20 deletes a document kind whose distribution frequency is not larger than a predetermined value (for example, 10 in a week) from the registration database 12, or deletes a predetermined number of document kinds having less distribution frequencies in the ascending order (namely, a predetermined number of document kinds in ascending order of their distribution frequencies) from the registration database 12.

It is preferable that the number of document kinds to be deleted from the registration database 12 by the deleting unit 20 is equal to the number of document kinds registered by the registration unit 16a. Alternatively, it is preferable that the registration unit 16a registers document kinds equal in number equal to document kinds deleted by the deleting unit 20, correspondingly to the process by the deleting unit 20. Accordingly, this allows the processes by the registration unit 16a and the deleting unit 20 to be linked more efficiently, which can keep the registration database 12 in the latest, excellent state.

The processes by the registration unit 16a and the deleting unit 20 may be carried out periodically at predetermined intervals, for example, after the end of the business everyday, or carried out when the number of registered document kinds reaches a predetermined value according to the number of registered document kinds in the registration candidate database 15a. Whereby, it is possible to update and manage the registration database 12, automatically and efficiently.

For example, the registration unit 16a looks over the registration database 12 once a month, registers, into the registration database 12, a document kind that remains in the higher rank for a month, and managing, in the registration candidate database 15a, the frequencies of ones that are not entered to the registration database 12. The registration unit 16a again examines one month later a chance of registration of each document kind that is continuously managed in the registration candidate database 15a. At this time, the registration unit 16a may delete one that has not been entered to the registration database 12 even after an elapse of almost one year because the distribution frequency of it is extremely small.

In the document discriminating apparatus 1a according to the embodiment of this invention, the registration unit 16a relates candidate information to a document kind on the basis of the registration frequency of the candidate information in the registration candidate database 15a by the temporary registration unit 14. Whereby, a person in charge who is required to have expert knowledge to register documents becomes unnecessary, and the registration database 12 can be updated to be, at any time, in an excellent state according to the distribution frequency of the documents. As a result, the rate of document discrimination of the document discriminating unit 13 is improved, thus a stable, excellent rate of document discrimination can be achieved.

Since the deleting unit 20 deletes a document kind whose distribution frequency is small from the registration database 12 according to the distribution frequency of the document kind, it is possible to delete a pair of an unnecessary document kind that is rarely used and document discrimination information thereof from the registration database 12. Accordingly, it becomes possible to prevent the number of document kinds retained in the registration database 12 from being increased, and the document discrimination rate of the document discriminating unit 13 from being degraded, which allows a stable, excellent document discrimination rate.

In other words, the registration unit 16a associates with the deleting unit 20 to register document kinds whose frequencies of use are large, while deleting ones whose frequencies of use are small, thereby keeping the data in the registration database 12 in an excellent state, at any time. Whereby, the efficiency of retrieval at the time of collation (discrimination) can be improved.

The deleting unit 20 does not delete, from the registration database 12, some document kinds that have specific distribution characteristics (refer to FIGS. 11 and 12) according to the distribution characteristic of each document kind, irrespective of whether the distribution frequencies thereof are large or small. Hence, it is possible to retain some document kinds that are invariably handled in a fixed period in the registration database 12 even if the distribution frequencies thereof are small, without deleting them. Accordingly, necessary documents can be always retained in the registration database 12 even if the distribution frequencies thereof are small, whereby the registration database 12 can be kept in an excellent state, in order to discriminate documents.

### [2] Modifications of the Invention

Note that the present invention is not limited to the above examples, but may be modified in various ways without departing from the scope of the invention.

### [2-1] First Modification

Now, a first modification of this invention will be described. In the forgoing embodiment, the registration unit 16a divides documents registered in the registration candidate database 15a into groups according to plural kinds of candidate information, and determines a document kind to be registered in the registration database 12 according to the number of documents in each of the divided groups. Instead, a registration unit 16b of a document discriminating apparatus 1b shown in FIG. 1 according to the first modification of this invention may determine a document kind to be registered in the registration database 12 on the basis of the registration frequency of one kind of candidate information.

For example, the registration unit 16b gives attention to the payer code as being the candidate information, and totalizes the number of times of registration of each of plural kinds of the payer code registered in the registration candidate database 15a. The registration unit 16b divides a plurality of documents registered in the registration candidate database 15b according to the payer code.

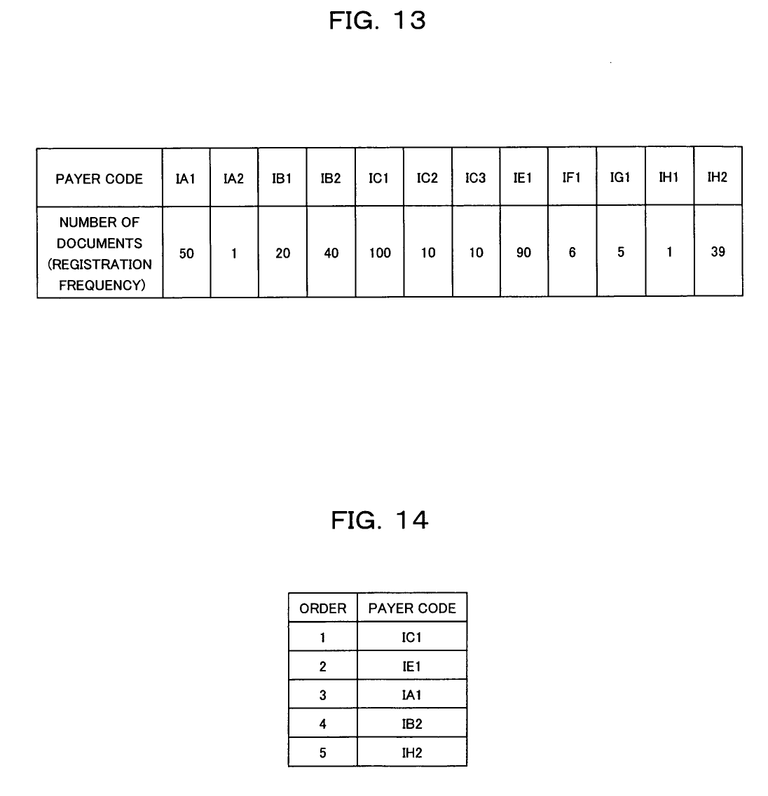

When the payer code is of 12 kinds,“IA1,” “IA2,” “IB1,” “IB2,” “IC1,” “IC2,” “IC3,” “IE1,” “IF1,” “IG1,” “IH1” and “IH2” as shown in FIG. 13, for example, the registration unit 16b calculates the registration frequency of each of the 12 kinds of the payer code.

Here, the registration unit 16b calculates the registration frequencies of the 12 kinds of the payer code, “IA1,” “IA2,” “IB1,” “IB2,” “IC1,” “IC2,” “IC3,” “IE1,” “IF1,” “IG1,” “IH1” and“IH2,” and obtains values of“50,” “1,”, “20”, “40,” “100,” “10,” “10,” “90,” “6,” “5,” “1” and “39” for them, respectively.

The registration unit 16b sorts them in the descending order of the registration frequency, as shown in FIG. 14, selects higher-scored five kinds of the payer code, and registers, in the registration database 12, these document kinds corresponding to documents to which these kinds of the payer code are entered.

Accordingly, the document discriminating apparatus 1b according to the first modification of this invention can provide the same effects as the foregoing embodiment.

### [2-2] Second Modification of the Invention

Next, a second modification of this invention will be described. In the forgoing embodiment, the registration unit 16a divides a plurality of documents registered in the registration candidate database 15a into a plurality of groups according to candidate information, and determines a document kind to be registered in the registration database 12 on the basis of the registration frequency of documents in each of the divided groups. As is shown in FIG. 1, in a document discriminating apparatus 1c according to the second modification of this invention, a registration unit 16c determines a document kind to be registered in the registration database 12 on the basis of a value obtained by totalizing the registration frequencies of plural kinds of candidate information of each document kind registered in the registration candidate database 15a. Particularly, each of plural kinds of candidate information is weighted, and a document kind having a larger total value (total score) of the weighted registration frequencies is determined as the document kind to be registered in the registration database 12.

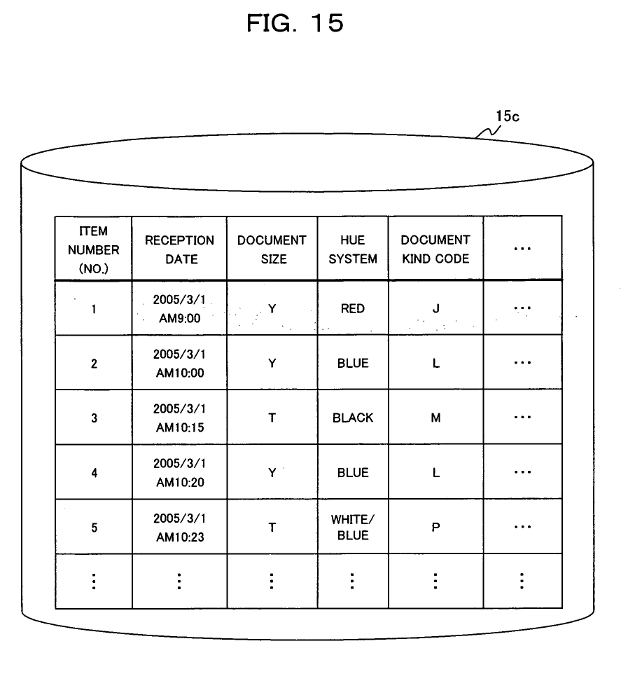

Now, the process of registering a document kind in the registration database 12 performed by the registration unit 16c will be described by way of example where the registration candidate database 15c is created by the temporary registration unit 14 as shown in FIGS. 15.

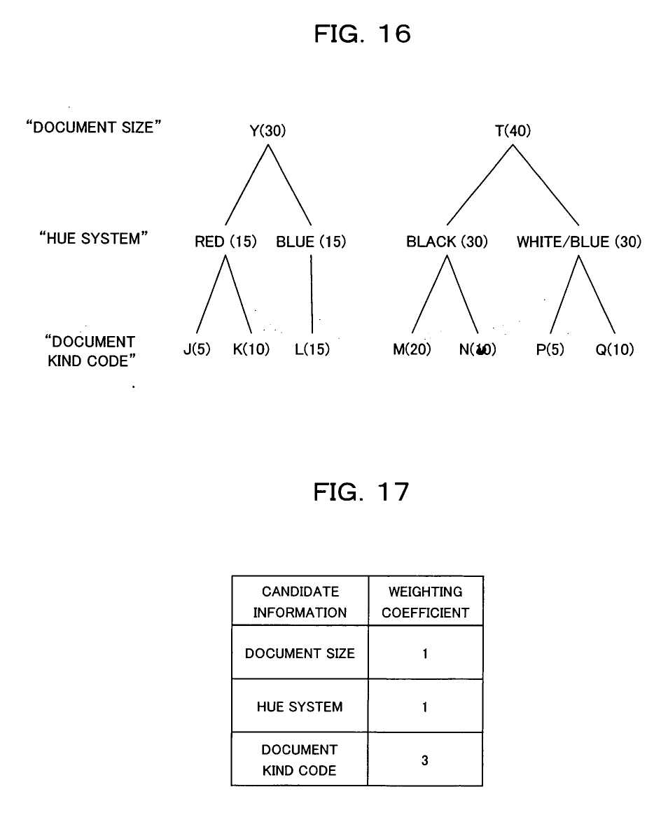

The registration unit 16c calculates the registration frequency of each of plural kinds of candidate information (here, “document size,” “hue system” and “document kind code”). FIG. 16 shows results of the calculation of the registration frequencies by the registration unit 16c in the tree structure. Incidentally, a numerical characteristic in parentheses in FIG. 16 represents the registration frequency (score) of relevant candidate information.

As shown in FIG. 16, there are “Y” and “T” as the document size, the registration frequencies of which are “30” and “40,” respectively, in the registration candidate database 15c shown in FIG. 15. As the hue system, there are “red,” “blue,” “black” and “white/blue,” the registration frequencies of which are “15,” “15,” “30” and “30,” respectively. As the document kind code, there are “J,” “K,” “L,” “M,” “N,” “P” and “Q,” the registration frequencies of which are “5,” “10,” “15,” “20,” “10,” “5” and “10,” respectively.

The registration unit 16c calculates a total score obtained by totaling the registration frequencies of respective sorts of candidate information on each document registered in the registration candidate database 15c, in consideration of a weighing coefficient for each sort of candidate information (weighting coefficient; here,“1” for the document size and hue system, and “3” for the document kind code) set beforehand as shown in FIG. 17, or set voluntarily by the operator.

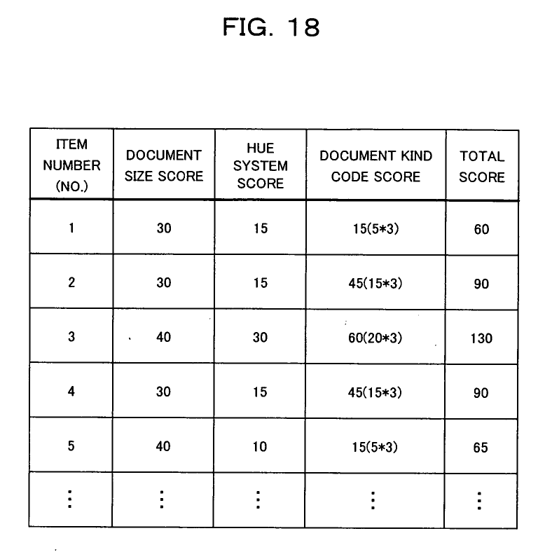

As shown in FIG. 18, the registration unit 16c obtains, as a score of the document kind code, a value by multiplying the registration frequency thereof by three, and, as scores of the document size and the hue system, obtains values by multiplying the respective registration frequencies by one. Then, the registration unit 16c totalizes the obtained scores of the candidate information on each document to calculate a total score.

For example, the registration unit 16c totalizes a score “30” of the document size “Y,” a score “15” of the hue system “red” and a score “15,” which is a triple value of a score “5” of the document type code, thereby obtaining a total score “60.” The registration unit 16c calculates total scores of the second and the following items in the same manner, as shown in FIG. 18.

The registration unit 16c registers document kinds having larger total scores in the registration database 12. Namely, the registration unit 16c registers, in the registration database 12, a predetermined number of document kinds having larger total scores in descending order, or registers, in the registration database 12, document kinds having total scores not less than a predetermined value.

As above, the document discriminating apparatus 1c according to the second modification of this invention can provide the same effects as the foregoing examples.

As still another modification of the registration unit 16c of the document discriminating apparatus 1c, the registration unit 16c may execute, at the beginning, an omitting process on the basis of values of the calculated total scores.

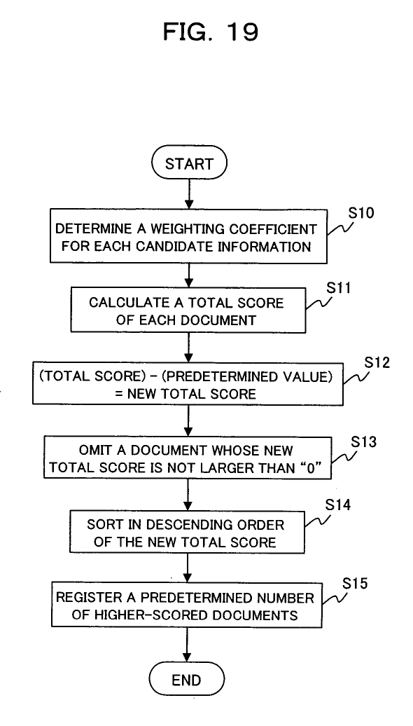

As shown in a flowchart (steps S10 to S15) in FIG. 19, the registration unit 16c determines a weighting coefficient for each sort of candidate information on the basis of the table shown in FIG. 17, for example, (step S10), and calculates a total score of each document kind, using the weighting coefficient, as shown in FIG. 18 (step S11).

The registration unit 16c subtracts a predetermined value beforehand set or the smallest score from the calculated total score of each document kind to calculates a new total score for each document kind (step S12).

The registration unit 16c determines not to register a document kind whose newly calculated score is not larger than“0”, and omits it (step S13).

The registration unit 16c sorts these document kinds in descending order of the new total score to rearrange them (step S14), registers document kinds ranging from one in the highest rank to one in a predetermined lower rank in the registration database 12 (step S15), and terminates the process.

By performing the omitting process by the registration unit 16c, it becomes possible to more efficiently execute registration of document kinds in the registration database 12, certainly register only document kinds having a predetermined frequency in the registration database 12, and improve the quality of the registration database 12.

### [2-3] Others

In the foregoing embodiments, the keyword database 16a-1 is provided, and the registration unit 16a divides a plurality of documents registered in the registration candidate database 15a on the basis of keywords retained in the keyword database 16a-1. However, this invention is not limited to this. Instead, the operator may voluntarily select keywords used for the dividing process with the keyboard 5 or the mouse 6, without the keyword database 16a-1, for example. In which case, the registration unit 16a divides a plurality of documents according to keywords selected by the operator, and determines document kinds to be registered in the registration database 12. Whereby, it becomes possible to more certainly reflect operator's intension to the document kinds to be registered in the registration database 12.

The functions of the document reading unit 11, the document discriminating unit 13, the temporary registration unit 14, the registration units 16a to 16c, the character recognizing unit 17, the updating unit 19 and the deleting unit 20 may be accomplished by executing a predetermined program [data medium discrimination information database creating (managing) program] by a computer (including CPU, information processing apparatus, various terminals).

Such program is provided in a form where the program is recorded on a computer readable recording medium such as a flexible disk, a CD (CD-ROM, CD-R, CD-RW, etc.), a DVD (DVD-ROM, DVD-RAM, DVD-R, DVD-RW, DVD+R, DVD+RW, etc.) or the like. In which case, the computer reads out the data medium discrimination information database creating (managing) program from the recording medium, transfers the program to the internal storage or an external storage unit, and stores the program therein to use the same program.

The program may be recorded on a storage (recording medium) such as a magnetic disk, an optical disk, a magneto-optic disk or the like, and provided to the computer over a communication line from the storage.

Here, a computer is a concept including hardware and an OS (operating system), standing for hardware operating under control of the OS. When the OS is unnecessary and the hardware is operated by solely the application program, the hardware itself corresponds to the computer. The hardware has, at least, a microprocessor such as a CPU or the like, and a means for reading the computer program recorded on the recording medium.

An application program as being the above data medium discrimination information database creating (managing) program includes program codes that make the above computer accomplish functions of the document reading unit 11, the document discriminating unit 13, the temporary registration unit 14, the registration units 16a to 16c, the character recognizing unit 17, the updating unit 19 and the deleting unit 20. Part of these functions may be accomplished by not the application program but the OS.

As the recording medium in the embodiments, besides a flexible disk, a CD, a DVD, a magnetic disk, an optical disk, and a magneto-optic disk mentioned above, usable are an IC card, a ROM cartridge, a magnetic tape, a punched card, an internal storage (memory such as a RAM, ROM, or the like) of the computer, an external storage, and various sorts of computer readable media such as a printed matter on which a code such as a bar code is printed or the like.

What is claimed is:

1. A data medium discrimination information database creating apparatus creating a data medium discrimination information database which relates data medium discrimination information used to discriminate a data medium on the basis of image data obtained by reading said data medium on which information is indicated to a data medium kind of said data medium, and retains the data medium discrimination information and the data medium kind, said data medium discrimination information database creating apparatus comprising:
a determining unit for determining whether or not the data medium discrimination information on said data medium obtained from the image data of said data medium is retained in said data medium discrimination information database;
a temporary registration unit for extracting candidate information which can be the data medium discrimination information on said data medium from the image data when said determining unit determines that the data medium discrimination information on said data medium is not retained in said data medium discrimination information database, relating the candidate information to said data medium, and registering the candidate information and said data medium in a registration candidate database; and
a registration unit for relating the candidate information to the data medium kind of said data medium, and registering the candidate information and the data medium kind of said data medium as the data medium discrimination information in said data medium discrimination information database on the basis of a registration frequency of the candidate information into said registration candidate database by said temporary registration unit.

2. The data medium discrimination information database creating apparatus according to claim 1, wherein said temporary registration unit extracts plural kinds of candidate information from said data medium, and registers the extracted candidate information in said registration candidate database; and
said registration unit divides a plurality of data media registered in said registration candidate database into a plurality of groups on the basis of the plural kinds of candidate information, and determines a data medium kind to be registered in said data medium discrimination information database on the basis of the registration frequencies of data media in each of the divided groups.

3. The data medium discrimination information database creating apparatus according to claim 2, wherein said registration unit registers, in said data medium discrimination information database, a predetermined number of data medium kinds in descending order of the registration frequency in each of the divided groups, and registers the selected data medium kinds in the data medium discrimination information database.

4. The data medium discrimination information database creating apparatus according to claim 2, wherein said registration unit registers, in said data medium discrimination database, a data medium kind whose registration frequency is above a predetermined value in each of the divided groups.

5. The data medium discrimination information database creating apparatus according to claim 1, wherein said temporary registration unit extracts plural kinds of candidate information from said data medium, and registers the extracted candidate information in said registration candidate database; and
said registration unit determines a data medium kind to be registered in said data medium discrimination information database on the basis of a value obtained by totaling registration frequencies of the plural kinds of candidate information on each data medium.

6. The data medium discrimination information database creating apparatus according to claim 1, wherein said temporary registration unit extracts plural kinds of candidate information from said data medium, and registers the extracted candidate information in said registration candidate database; and
said registration unit determines a data medium kind to be registered in said data medium discrimination information database on the basis of a total value obtained by weighting a registration frequency of each of the plural kinds of candidate information on each data medium and totaling the weighted registration frequencies.

7. The data medium discrimination information database creating apparatus according to claim 5, wherein said registration unit registers, in said data medium discrimination information database, a predetermined number of data medium kinds in descending order of the total value.

8. The data medium discrimination information database creating apparatus according to claim 5, wherein said registration unit registers, in said data medium discrimination information database, a data medium kind whose total value is above a predetermined value.

9. The data medium discrimination information database creating apparatus according to claim 1 further comprising:
a distribution frequency database for retaining a distribution frequency of each data medium kind whose data medium discrimination information is retained in said data medium discrimination information database;
an updating unit for updating the distribution frequency of a data medium kind in said distribution frequency database when said determining unit determines that data medium discrimination information on said data medium is retained in said data medium discrimination information database; and
a deleting unit for deleting a pair of a data medium kind and data medium discrimination information thereof from said data medium discrimination information database on the basis of the distribution frequency of the data medium kind in said distribution frequency database.

10. The data medium discrimination information database creating apparatus according to claim 9, wherein said deleting unit deletes, from said data medium discrimination information database, a predetermined number of pairs of data medium kinds and data medium discrimination information thereof in ascending order of the distribution frequency.

11. The data medium discrimination information database creating apparatus according to claim 9, wherein said deleting unit deletes, from said data medium discrimination information database, a pair of a data medium kind and data medium discrimination information thereof whose distribution frequency is below a predetermined value.

12. A data medium discrimination information database managing apparatus managing a data medium discrimination information database which relates data medium discrimination information used to discriminate a data medium on the basis of image data obtained by reading said data medium on which information is indicated to a data medium kind of said data medium, said data medium discriminating information database managing apparatus comprising:
a distribution frequency database for retaining a distribution frequency of each data medium kind whose data medium discrimination information is retained in said data medium discrimination information database;
a determining unit for determining whether or not data medium discrimination information on said data medium obtained from the image data of said data medium is retained in said medium discrimination information database;
an updating unit for updating the distribution frequency of a data medium kind of said data medium in said distribution frequency database when said determining unit determines that the data medium discrimination information on said data medium is retained in said data medium discrimination information database; and
a deleting unit for deleting a pair of a data medium kind and data medium discrimination information thereof from said data medium discrimination information database on the basis of the distribution frequency of the data medium kind in said distribution frequency database.

13. A computer readable recoding medium recorded thereon a data medium discrimination information database creating program for making a computer accomplish a function of creating a data medium discrimination information database in which data medium discrimination information used to discriminate a data medium on the basis of image data obtained by reading said data medium on which information is indicated is related to a data medium kind of said data medium, and the data medium discrimination information and the data medium kind are retained,
said data medium discrimination information database creating program making said computer function as:
a determining unit for determining whether or not the data medium discrimination information on said data medium obtained from the image data of said data medium is retained in said data medium discrimination information database;
a temporary registration unit for extracting candidate information which can be the data medium discrimination information on said data medium from the image data when said determining unit determines that the data medium discrimination information on said data medium is not retained in said data medium discrimination information database, relating the candidate information to said data medium, and registering the candidate information and said data medium in a registration candidate database; and
a registration unit for relating the candidate information to the data medium kind of said data medium, and registering the candidate information and the data medium kind of said data medium as the data medium discrimination information in said data medium discrimination information database on the basis of a registration frequency of the candidate information into said registration candidate database by said temporary registration unit.

14. The computer readable recording medium recorded thereon a data medium discrimination information database creating program according to claim 13, wherein the data medium discrimination information database creating program makes said computer function so that:
said temporary registration unit extracts plural kinds of candidate information from said data medium, and registers the extracted candidate information in said registration candidate database; and
said registration unit divides a plurality of data medium registered in said registration candidate database into a plurality of groups on the basis of the plural kinds of candidate information, and determines a data medium kind to be registered in said data medium discrimination information database on the basis of the registration frequencies of data media in each of the divided groups.

15. The computer readable recording medium recorded thereon a data medium discrimination information database creating program according to claim 13, wherein the data medium discriminating information database creating program makes said computer function so that:
said temporary registration unit extracts plural kinds of candidate information from said data medium, and registers the extracted candidate information in said registration candidate database; and
said registration unit determines a data medium kind to be registered in said data medium discrimination information database on the basis of a value obtained by totaling registration frequencies of the plural kinds of candidate information on each data medium.

16. The computer readable recording medium recorded thereon a data medium discrimination information database creating program according to claim 13, wherein the data medium discrimination information database creating program makes said computer function so that:
said temporary registration unit extracts plural kinds of candidate information from said data medium, and registers the extracted candidate information in said registration candidate database; and
said registration unit determines a data medium kind to be registered in said data medium discrimination information database on the basis of a total value obtained by weighting a registration frequency of each of the plural kinds of candidate information on each data medium and totaling the weighted registration frequencies.

17. The computer readable recording medium recorded thereon a data medium discrimination information database creating program according to claim 13, wherein the data medium discrimination information database creating program makes said computer further function as:
an updating unit for, when said determining unit determines that data medium discrimination information on said data medium is retained in said data medium discrimination information database, updating a distribution frequency of a data medium kind of said data medium in a distribution frequency database retaining the distribution frequency of each data medium kind whose data medium discrimination information is retained in said data medium discrimination information database; and
a deleting unit for deleting a pair of a data medium kind and data medium discrimination information thereof from said data medium discrimination information database on the basis of the distribution frequency of the data medium kind in said distribution frequency database.

18. A data medium discriminating apparatus comprising:
an image data obtaining unit for reading a data medium on which information is indicated to obtain image data thereof;
a data medium discrimination information database for relating data medium discrimination information used to discriminate said data medium to a data medium kind of said data medium, and retaining the data medium discrimination information and the data medium kind;
a data medium discriminating unit for discriminating said data medium on the basis of the image data of said data medium obtained by said image data obtaining unit and the data medium discrimination information retained in said data medium discrimination information database;
a temporary registration unit for extracting candidate information which can be the data medium discrimination information on said data medium from the image data, and registering the extracted candidate information in a registration candidate database when said data medium discriminating unit cannot discriminate said data medium because the data medium discrimination information on said data medium is not retained in said data medium discrimination information database; and
a registration unit for relating the candidate information to the data medium kind of said data medium, and registering the candidate information and the data medium kind of said data medium as data medium discrimination information in said data medium discrimination information database on the basis of a registration frequency of the candidate information into said registration candidate database by said temporary registration unit.

19. The data medium discriminating apparatus according to claim 18 further comprising:
a distribution frequency database for retaining a distribution frequency of each data medium kind whose data medium discrimination information is retained in said data medium discrimination information database;
an updating unit for updating the distribution frequency of a data medium kind in said distribution frequency database when said data medium discriminating unit discriminates said data medium because the data medium discrimination information on said data medium is retained in said data medium discrimination information database; and
a deleting unit for deleting a pair of a data medium kind and data medium discrimination information thereof from said data medium discrimination information database on the basis of the distribution frequency of the data medium kind in said distribution frequency database.

20. A data medium discriminating apparatus comprising:
an image data obtaining unit for reading a data medium on which information is indicated to obtain image data thereof;
a data medium discrimination information database for relating data medium discrimination information used to discriminate said data medium to a data medium kind of said data medium, and retaining the data medium discrimination information and the data medium kind;
a data medium discriminating unit for discriminating said data medium on the basis of the image data of said data medium obtained by said image data obtaining unit and the data medium discrimination information retained in said data medium discrimination information database;
a distribution frequency database for retaining a distribution frequency of each data medium kind whose data medium discrimination information is retained in said data medium discrimination information database;
an updating unit for updating the distribution frequency of a data medium kind in said distribution frequency database when said data medium discriminating unit discriminates said data medium because data medium discrimination information on said data medium is retained in said data medium discrimination information database; and
a deleting unit for deleting a pair of a data medium kind and data medium discrimination information thereof from said data medium discrimination information database on the basis of the distribution frequency of the data medium kind in said distribution frequency database.
